(19) United States
(12) Patent Application Publication
(10) Pub. No.: US 2014/0149207 A1
(43) Pub. Date: May 29, 2014

(54) SYSTEM AND METHOD FOR IMPLEMENTING ADVERTISEMENT PUSH AND MARKETING

(71) Applicants: INVENTEC (PUDONG) TECHNOLOGY CORPORATION, (US); INVENTEC CORPORATION, Taipei (TW)

(72) Inventor: Chaucer CHIU, Shanghai (CN)

(73) Assignees: INVENTEC CORPORATION, Taipei (TW); INVENTEC (PUDONG) TECHNOLOGY CORPORATION, Shanghai (CN)

(21) Appl. No.: 13/795,442

(22) Filed: Mar. 12, 2013

(30) Foreign Application Priority Data
Nov. 26, 2012 (CN) 201210489269.1

(51) Int. Cl. G06Q 30/02

(52) U.S. Cl. CPC G06Q 30/0266
USPC 705/14.45; 705/14.63

(57) ABSTRACT

A system and method for implementing advertisement push and marketing are provided. Target location information and location information are provided by a client. A driving path is planned by a server according to the target location information and the location information, so that an advertisement corresponding to the location information is queried. The queried advertisement is fed back and provided for users to click. Therefore, the technical efficacy of implementing advertisement push and marketing is achieved.

### BACKGROUND OF THE INVENTION

1. Field of the Invention

The present invention relates to a system and method of advertisement push and marketing, and more particularly to a system and method for implementing advertisement push and marketing.

2. Description of Related Art

Due to the rapid development of technologies, more and more devices applied in vehicles are developed, such as a navigation device, a driving recording device, a metering device, and a wireless device, which are mostly applied and developed for the drivers.

Accordingly, devices used for passengers also need to be gradually developed. The existing devices used for the passengers generally only provide the users with functions such as video watching and music playback, and more business opportunities can be provided for enterprises if advertisements are inserted in the video watching or music playback.

However, the existing vehicle-mounted device repeatedly plays a fixed advertisement, which causes the boredom of the passengers. The manner of providing different advertisements according to the driving path of the passengers may avoid causing the boredom of the users, and further provide a preferred method for implementing advertisement push and marketing.

It can be known from the above that, the prior art has the problem that the existing vehicle-mounted device repeatedly plays a fixed advertisement and fails to play advertisements properly according to the vehicle location. Therefore, it is necessary to propose an improved technical means for solving such a problem.

### SUMMARY OF THE INVENTION

To solve the problem in the prior art that the existing vehicle-mounted device repeatedly plays a fixed advertisement and fails to play advertisements properly according to the vehicle location, the present invention discloses a system and method for implementing advertisement push and marketing.

The system for implementing advertisement push and marketing disclosed by the present invention includes a server and a client. The server further includes an advertisement database, a server receiving module, a comparison module, a query module, and a server transfer module. The client further includes a client receiving module, a connection module, and a play module.

The advertisement database of the server stores multiple data, and each data includes a location range and an advertisement which is corresponding to the location range. The server receiving module of the server is used for receiving target location information and location information, and receiving the location information again at each predetermined interval. The comparison module of the server is used for comparing whether the location information falls in the location range of any data. The query module of the server is used for querying the advertisement corresponding to the location range from the advertisement database when the comparison module determines the location range which the location information falls in. The server transfer module of the server is used for transferring all the queried advertisements.

The client is installed in a vehicle. The client receiving module of the client is used for receiving the target location information and the location information. The connection module of the client is used for establishing a connection with the server, providing the target location information and the location information which are from the client receiving module to the server receiving module, and acquiring the advertisement from the server transfer module. The play module of the client is used for cyclically playing all the received advertisements.

The method for implementing advertisement push and marketing disclosed in the present invention includes the following steps.

A client which is installed in a vehicle receives target location information and location information. The client establishes a connection with a server, and provides the target location information and the location information to the server. The server pre-establishes an advertisement database which stores multiple data, each data including a location range and an advertisement which is corresponding to the location range. The server acquires the location information again from the client at each a predetermined interval. The server compares whether the location information falls in the location range of any data. When the server determines the location range which the location information falls in, the advertisement corresponding to the location range is queried from the advertisement database. The server provides all the queried advertisements to the client. The client cyclically plays all the received advertisements.

The above system and method disclosed in the present invention are different from the prior art in that, in the present invention, the client provides the target location information and the location information, and the server queries the advertisement corresponding to the location information according to the target location information and the location information, and feeds back the queried advertisement to be played for the user, thereby avoiding causing the boredom of the user when repeatedly watching the fixed advertisement.

Through the above technical means, the present invention can achieve the technical efficacy of implementing advertisement push and marketing.

### BRIEF DESCRIPTION OF THE DRAWINGS

The invention will become more fully understood from the detailed description given herein below illustration only, and thus is not limitative of the present invention, and wherein:

FIG. 1 is a block diagram of a system for implementing advertisement push and marketing according to the present invention.

FIGS. 2A to 2C are flow charts of a method for implementing advertisement push and marketing according to the present invention.

FIG. 3 is a schematic view of a user interface for implementing advertisement push and marketing according to the present invention.

FIG. 4 is a schematic view of an advertisement database for implementing advertisement push and marketing according to the present invention.

FIG. 5 is a schematic structural view of a system for implementing advertisement push and marketing according to the present invention.

FIG. 6 is a schematic view of advertisement playing for implementing advertisement push and marketing according to the present invention.

FIG. 7 is a schematic view of a display result for implementing advertisement push and marketing according to the present invention.

FIG. 8 is a schematic view of advertisement playing for implementing advertisement push and marketing according to the present invention.

FIG. 9 is a schematic view of a display result of promotional information for implementing advertisement push and marketing according to the present invention.

### DESCRIPTION OF THE EMBODIMENTS

The implementation manners of the present invention are illustrated in detail hereinafter with reference to the accompanying drawings and embodiments, thereby facilitating the full comprehension and implementation of the process of solving the technical problem and achieving the technical efficacy by applying the technical means in the present invention.

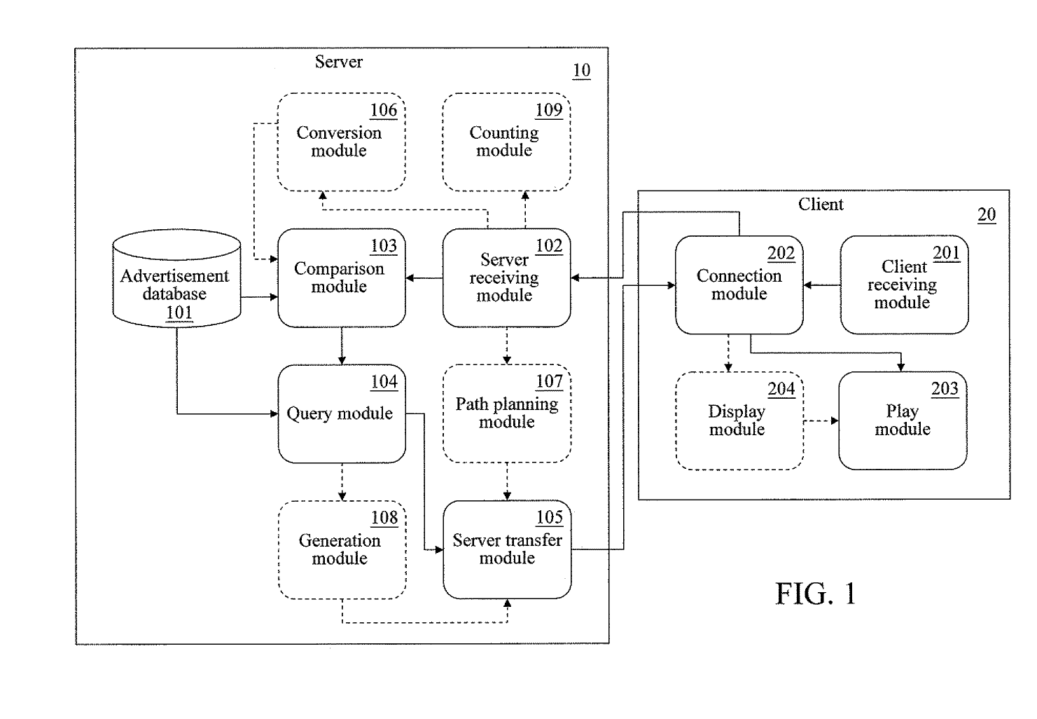

Hereinafter, a system for implementing advertisement push and marketing disclosed in the present invention is illustrated first. Referring to FIG. 1, FIG. 1 is a block diagram of the system for implementing advertisement push and marketing according to the present invention.

The system for implementing advertisement push and marketing disclosed in the present invention includes: a server 10 and a client 20. The server 10 further includes an advertisement database 101, a server receiving module 102, a comparison module 103, a query module 104, and a server transfer module 105. The client 20 further includes a client receiving module 201, a connection module 202, and a play module 203.

The client 20 is installed in a vehicle, and may be a touch display device or a combination of a display device and an input device, which is illustrated as an example herein and not intended to limit the application scope of the present invention. The client 20 is mainly an input and display device for a passenger and a driver.

The passenger or the driver may input target location information through the touch display device or the input device of the client 20, and the target location information may be an address, a name (for example, organization name, building name, company name, and the like), a global positioning coordinate, and so on, which is illustrated as an example herein and not intended to limit the application scope of the present invention.

After the passenger or the driver inputs the target location information, the client receiving module 201 of the client 20 receives the target location information input by the passenger or the driver. The client receiving module 201 of the client 20 may also receive the location information via a Global Positioning System (GPS), the location information being the current location of the global positioning coordinate of the vehicle.

The connection module 202 of the client 20 establishes a connection with the server 10 in a wireless manner (for example, WIFI, 3G mobile communications, and so on), and provides the target location information and the location information received by the client receiving module 201 of the client 20 to the server 10.

The server 10 pre-establishes the advertisement database 101 which stores multiple data, each data including a location range and an advertisement. The location range covers a plurality of established global positioning coordinates.

The server receiving module 102 of the server 10 receives the target location information and the location information from the client receiving module 201 of the client 20. When the target location information received by the server receiving module 102 of the server 10 is a non-global positioning coordinate (i.e., an address, a name, and so on), a conversion module 106 further included in the server 10 converts the target location information into a format for query in the advertisement database. That is, the conversion module 106 of the server 10 converts the non-global positioning coordinate as the target location information into the global positioning coordinate. The non-global positioning coordinate is converted into the global positioning coordinate by means of comparison of a data table, or by referring to the conventional technologies of converting the non-global positioning coordinate into the global positioning coordinate, which is not illustrated in detail again herein and not intended to limit the application scope of the present invention.

The comparison module 103 of the server 10 may also compare whether the location information falls in the location range stored in the advertisement database 101, when the server receiving module 102 of the server 10 receives the target location information and the location information.

Specifically, assuming that the location information received by the server receiving module 102 of the server 10 is “120°48′05″ E, 24°28′25″ N”, and the advertisement database 101 stores a location range being “120° 48′00″ E, 24°28′30″ N”, “120°48′10″ E, 24°28′30″ N”, “120°48′00″ E, 24°28′20″ N”, and “120°48′10″ E, 24°28′20″ N”, the comparison module 103 of the server 10 may determine by comparison that the location information being “120°48′05″ E, 24°28′25″ N” falls in the location range.

Moreover, when the comparison module 103 of the server 10 determines by comparison the location range that the location information falls in, the query module 104 of the server 10 queries the advertisement corresponding to the location range from the advertisement database 101.

Specifically, assuming that the comparison module 103 of the server 10 determines by comparison that the location information falls in a first location range and a second location range, the query module 104 of the server 10 queries a first advertisement corresponding to the first location range from the advertisement database 101, and queries a second advertisement corresponding to the second location range from the advertisement database 101.

It is not just once that the server receiving module 102 of the server 10 receives the location information provided by the connection module 202 of the client 20, and the server receiving module 102 of the server 10 may receive the location information again at a predetermined interval. The predetermined interval may be “30 seconds”, “1 minute”, and so on, which is illustrated as an example herein and not intended to limit the application scope of the present invention.

Whenever the server receiving module 102 of the server 10 receives the location information, the comparison module 103 and the query module 104 of the server 10 query new advertisements, and the server transfer module 105 of the server 10 provides all the queried advertisements to the connection module 202 of the client 20.

After the connection module 202 of the client 20 acquires the advertisements, the play module 203 of the client 20 cyclically plays all the received advertisements.

The server 10 further includes: a path planning module 107, a generation module 108, and a counting module 109. The path planning module 107 of the server 10 is used for planning a driving path from the location information to the target location information. The path planning module 107 of the server 10 plans the driving path from the location information to the target location information in the manner as described in the prior art, which is not illustrated again herein. The existing path planning manners can all be implemented in the present invention.

When the query module 104 of the server 10 queries the advertisement corresponding to the location range from the advertisement database 101, the generation module 108 of the server 10 generates an advertisement list from the queried advertisements, and the server transfer module 105 of the server 10 provides the driving path and the advertisement list to the connection module 202 of the client 20.

Definitely, when the server receiving module 102 of the server 10 receives the location information again at a predetermined interval, the path planning module 107, the comparison module 103, the query module 104, and the generation module 108 of the server 10 may be used to plan a new driving path and generate a new advertisement list, and the server transfer module 105 of the server 10 provides the driving path and the advertisement list to the connection module 202 of the client 20.

After the connection module 202 of the client 20 acquires the driving path and the advertisement list, a display module 204 further included in the client 20 displays the driving path on an electronic map, and also displays the advertisement list. The passenger may click the advertisement in the advertisement list, and the clicked advertisement is played by the play module 203 of the client 20.

The counting module 109 of the server 10 is used for counting clicked times of the advertisements in the advertisement list, and after the counting module 109 of the server 10 counts the clicked times of the advertisements in the advertisement list, subsequent operations such as data analysis and charging management can be conducted.

Each data in the advertisement database 101 further includes preferential information. The comparison module 103 of the server 10 further determines by comparison the location range that the target information falls in. The query module 104 of the server 10 queries the preferential information corresponding to the location range from the advertisement database 101. The server transfer module 105 of the server 10 provides the preferential information to the connection module 202 of the client 20. That is, the display module 204 of the client 20 displays the preferential information. The passenger may capture images of the preferential information by means of a handheld device, or acquire the preferential information from the client 20 in wireless (for example, WIFI, Bluetooth, and so on), so that the passenger can use the preferential information in a store at a destination after arriving at the destination. The preferential information includes a combination of characters, images, and barcodes.

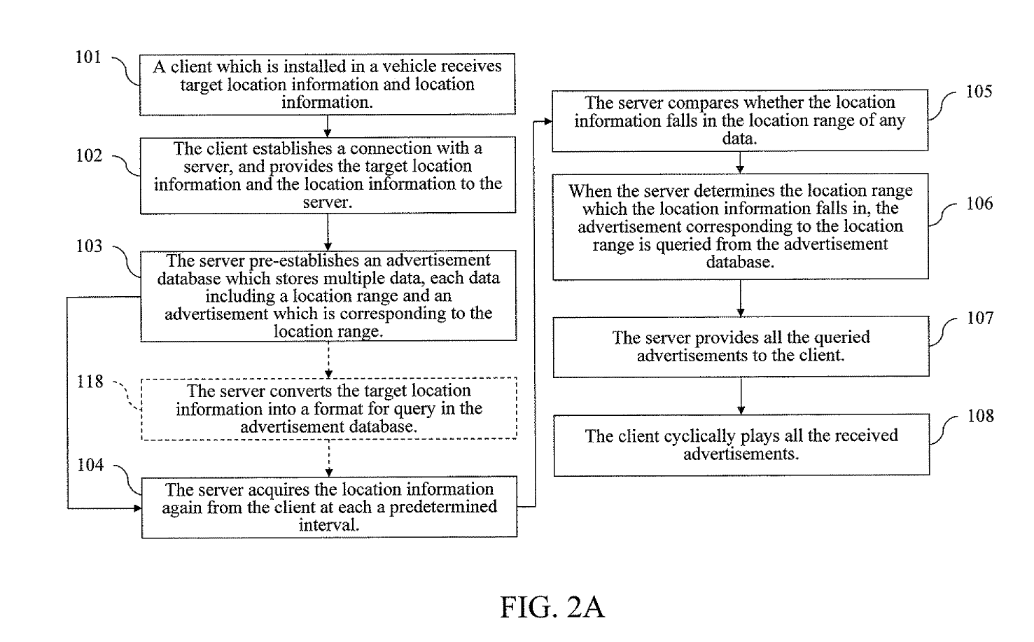

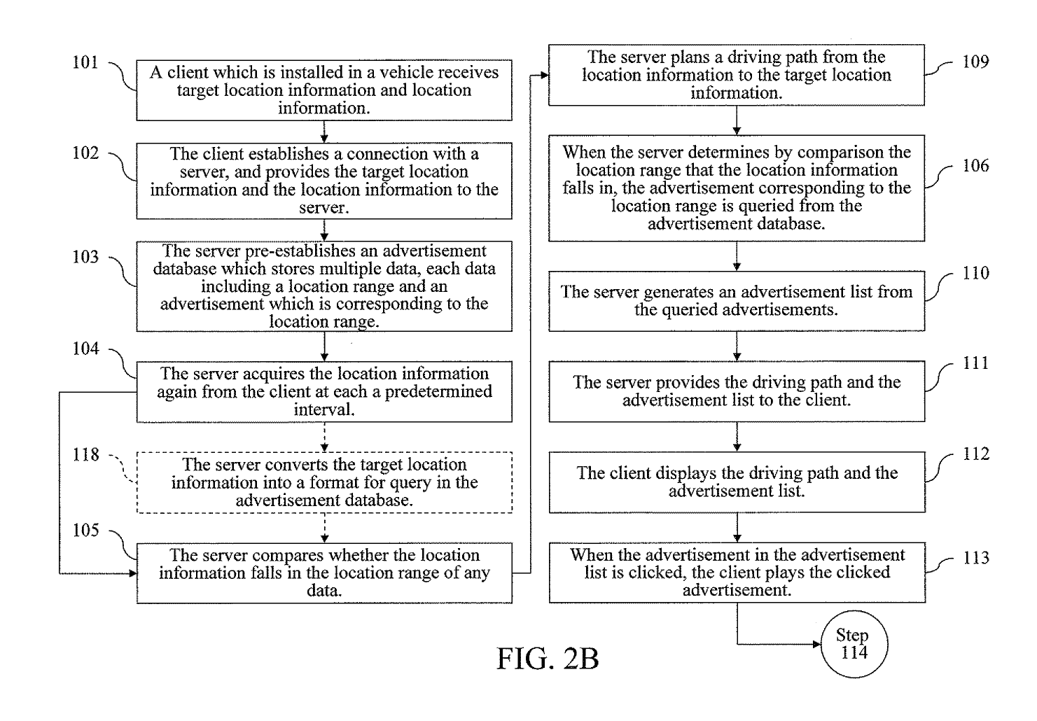

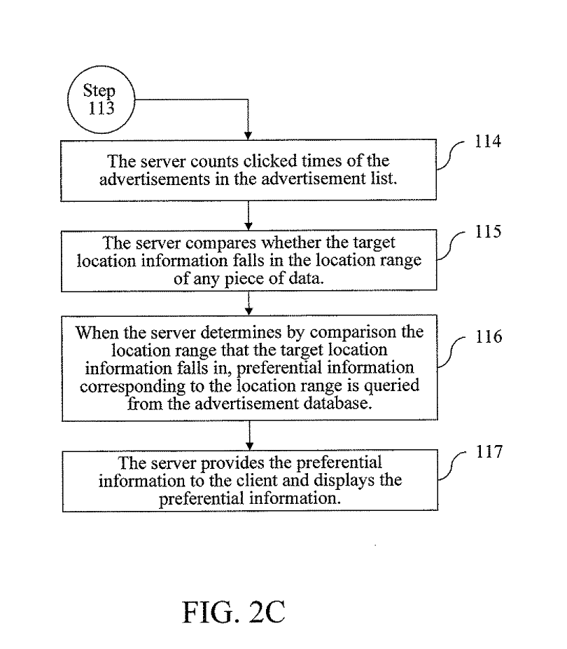

An embodiment is used hereinafter to illustrate the operating manner and flow of the present invention with reference to FIG. 1 and FIGS. 2A to 2C. FIGS. 2A to 2C are flow charts of a method for implementing advertisement push and marketing according to the present invention.

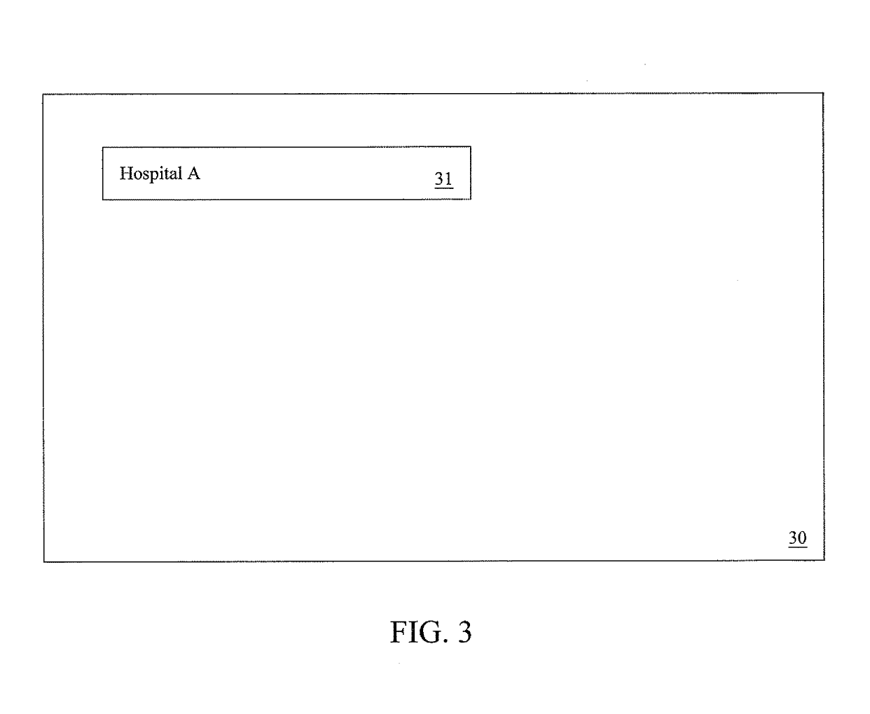

Referring to FIG. 3, FIG. 3 is a schematic view of a user interface for implementing advertisement push and marketing according to the present invention.

A passenger firstly inputs target location information 31 being “Hospital A” through the user interface 30 provided by the client 20 installed in a vehicle, and the client receiving module 201 of the client 20 receives the target location information 31 being “Hospital A” input by the passenger (Step 101). The client 20 may be a touch display device or a combination of a display device and an input device, which is merely taken as an example for illustration herein and is not intended to limit the application scope of the present invention. The client 20 is mainly an input and display device for the passenger and the driver.

The client receiving module 201 of the client 20 may also receive location information 32 being “120°48′05″ E, 24°28′25″ N” via a GPS, and the location information 32 being “120°48′05″ E, 24°28′25″ N” is the current location of the global positioning coordinate of the vehicle (Step 101).

The connection module 202 of the client 20 establishes a connection with the server 10 by means of wireless of 3G mobile communications, and provides the target location information 31 being “Hospital A” and the location information 32 being “120°48′05″ E, 24°28′25″ N” received by the client receiving module 201 of the client 20 to the server 10 (Step 102).

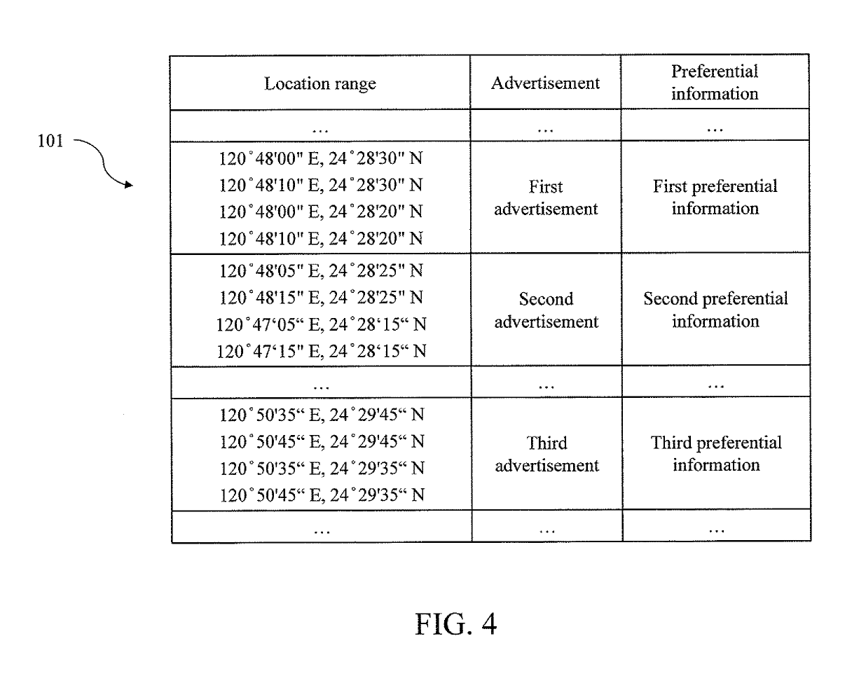

Referring to FIG. 4, FIG. 4 is a schematic view of an advertisement database for implementing advertisement push and marketing according to the present invention.

The advertisement database 101 is pre-established in the server 10. In the embodiment, the advertisement database 101 stores three kinds of data. The first kind of data includes a location range being “120°48′00″ E, 24°28′30″ N”, “120°48′10″ E, 24°28′30″ N”, “120°48′00″ E, 24°28′20″ N”, and “120°48′10″ E, 24°28′20″ N”, as well as an advertisement being “a first advertisement” and preferential information being “first preferential information”. The second kind of data includes a location range being “120°48′05″ E, 24°28′25″ N”, “120°48′15″ E, 24°28′25″ N”, “120°47′05″ E, 24°28′15″ N”, and “120°47′15″ E, 24°28′15″ N”, as well as an advertisement being “a second advertisement” and preferential information being “second preferential information”. The third kind of data includes a location range being “120°50′35″ E, 24°29′45″ N”, “120°50′45″ E, 24°29′45″ N”, “120°50′35″ E, 24°29′35″ N”, and “120°50′45″ E, 24°29′35″ N”, as well as an advertisement being “a third advertisement” and preferential information being “third preferential information” (Step 103).

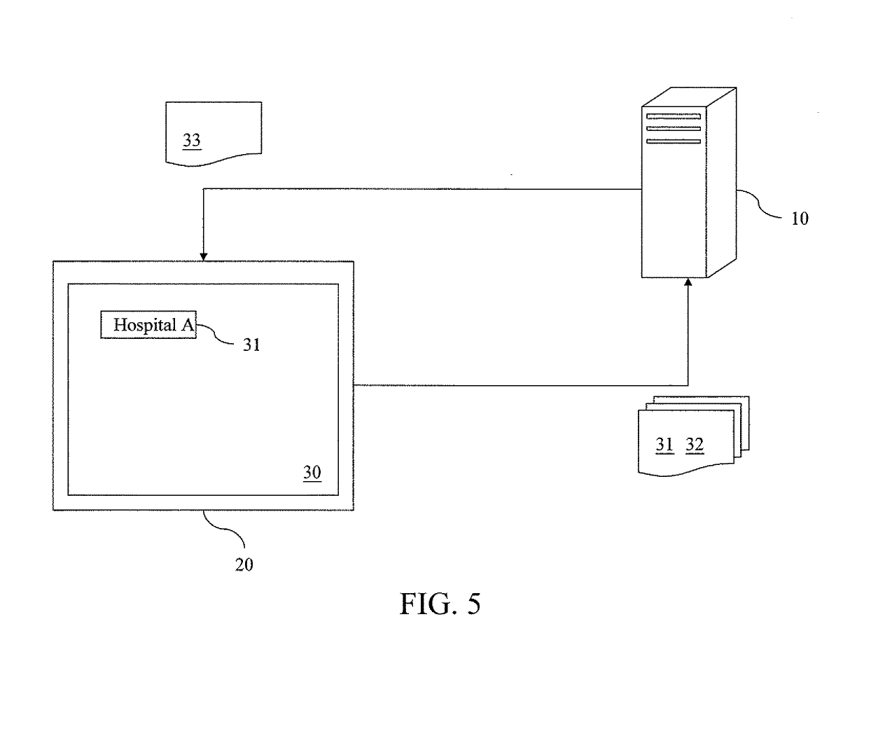

Referring to FIG. 4 and FIG. 5, FIG. 5 is a schematic structural view of a system for implementing advertisement push and marketing according to the present invention.

The server receiving module 102 of the server 10 receives the target location information 31 being “Hospital A” and the location information 32 being “120°48′05″ E, 24°28′25″ N” from the client receiving module 201 of the client 20. Since the target location information 31 received by the server receiving module 102 of the server 10 is “Hospital A” (which is a non-global positioning coordinate), the conversion module 106 further included in the server 10 converts the target location information 31 being “Hospital A” into a format for query in the advertisement database 101 (Step 118), i.e., converts the target location information 31 being “Hospital A” into a global positioning coordinate being “120′50′40″ E, 24°29′40″ N”. The non-global positioning coordinate is converted into the global positioning coordinate by means of comparison of a data table, or by referring to the conventional technologies of converting the non-global positioning coordinate into the global positioning coordinate, which is not illustrated in detail again herein and not intended to limit the application scope of the present invention.

When the server receiving module 102 of the server 10 receives the target location information 31 being “120°50′40″ E, 24°29′40″ N” and the location information 32 being “120°48′05″ E, 24°28′25″ N”, the comparison module 103 of the server 10 compares whether the location information 32 being “120°48′05″ E, 24°28′25″ N” falls in the location range stored in the advertisement database 101 (Step 105).

In the embodiment, the comparison module 103 of the server 10 determines by comparison that the location information 32 being “120°48′05″ E, 24°28′25″ N” falls in the location range being “120°48′00″ E, 24°28′30″ N”, “120°48′10″ E, 24°28′30″ N”, “120°48′00″ E, 24°28′20″ N”, and “120′48′10″ E, 24°28′20″ N” of the first kind of data (Step 105), and that the location information 32 being “120°48′05″ E, 24°28′25″ N” falls in the location range being “120°48′05″ E, 24°28′25″ N”, “120°48′15″ E, 24°28′25″ N”, “120°47′05″ E, 24°28′15″ N”, and “120°47′15″ E, 24°28′15″ N” of the second kind of data (Step 105).

The query module 104 of the server 10 queries from the advertisement database 101 that the advertisements corresponding to the above location range are respectively “the first advertisement” and “the second advertisement” (Step 106), and the server transfer module 105 of the server 10 provides the queried advertisements being “the first advertisement” and “the second advertisement” to the connection module 202 of the client 20 (Step 107).

It is not just once that the server receiving module 102 of the server 10 receives the location information provided by the connection module 202 of the client 20, and the server receiving module 102 of the server 10 may receive the location information again at a predetermined interval (Step 104). The predetermined interval may be “30 seconds”, “1 minute”, and so on, which is illustrated as an example herein and not intended to limit the application scope of the present invention.

Whenever the server receiving module 102 of the server 10 receives the location information, the comparison module 103 and the query module 104 of the server 10 query new advertisements, and the server transfer module 105 of the server 10 provides all the queried advertisements to the connection module 202 of the client 20.

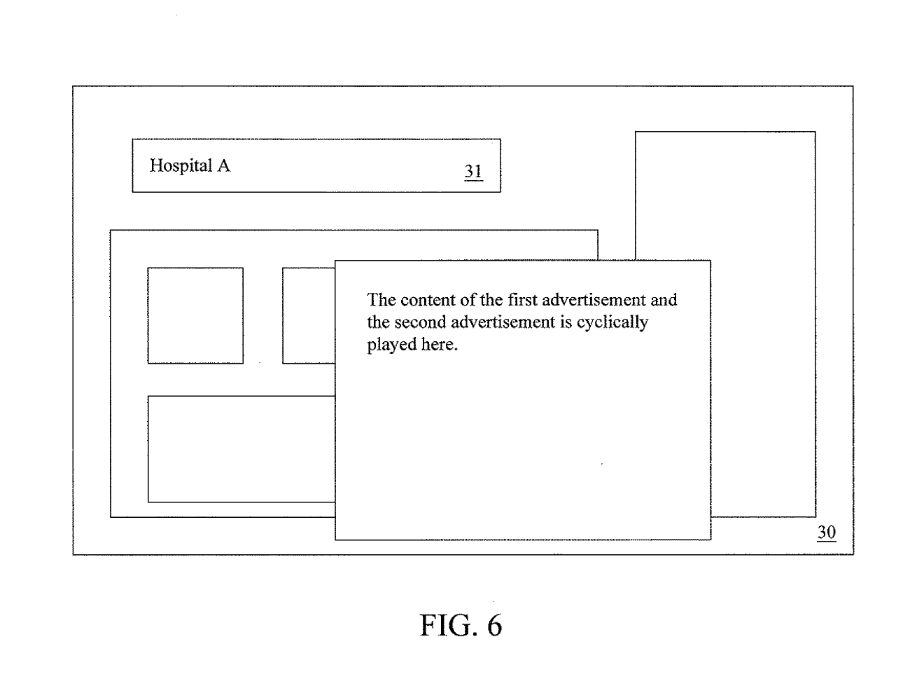

After the connection module 202 of the client 20 acquires the advertisements being “the first advertisement” and “the second advertisement”, the play module 203 of the client 20 cyclically plays “the first advertisement” and “the second advertisement” (Step 108). The playing of the advertisements is shown in FIG. 6, and FIG. 6 is a schematic view of advertisement playing for implementing advertisement push and marketing according to the present invention.

Referring to FIG. 4 and FIG. 5 again, the path planning module 107 further included in the server 10 plans a driving path from the location information 32 being “120°48′05″ E, 24°28′25″ N” to the target location information 31 being “120°50′40″ E, 24°29′40″ N” (Step 109). The path planning module 107 of the server 10 plans the driving path from the location information to the target location information in the manner as described in the prior art, which is not illustrated again herein. The existing path planning manners can all be implemented in the present invention.

The comparison module 103 of the server 10 determines by comparison that the location information 32 being “120°48′05″ E, 24°28′25″ N” falls in the location range being “120°48′00″ E, 24°28′30″ N”, “120°48′10″ E, 24°28′30″ N”, “120°48′00″ E, 24°28′20″ N”, and “120°48′10″ E, 24°28′20″ N” of the first kind of data (Step 105), and that the location information 32 being “120°48′05″ E, 24°28′25″ N” falls in the location range being “120°48′05″ E, 24°28′25″ N”, “120°48′15″ E, 24°28′25″ N”, “120°47′05″ E, 24°28′15″ N”, and “120°47′15″ E, 24°28′15″ N” of the second kind of data (Step 105).

The query module 104 of the server 10 queries from the advertisement database 101 that the advertisements corresponding to the above location range are respectively “the first advertisement” and “the second advertisement”, and the generation module 108 of the server 10 generates an advertisement list 33 from the queried advertisements being respectively “the first advertisement” and “the second advertisement” (Step 110).

After the path planning module 107 of the server 10 plans the driving path from the location information 32 being “120°48′05″ E, 24°28′25″ N” to the target location information 31 being “120°50′40″ E, 24°29′40″ N”, and the generation module 108 of the server 10 generates the advertisement list 33 from the queried advertisements being respectively “the first advertisement” and “the second advertisement”, the server transfer module 105 of the server 10 provides the driving path and the advertisement list 33 to the connection module 202 of the client 20 (Step 111).

Whenever the server receiving module 102 of the server 10 receives the location information, the path planning module 107, the comparison module 103, the query module 104, and the generation module 108 of the server 10 are used to plan a new driving path and generate a new advertisement list (Step 110), and the server transfer module 105 of the server 10 provides the driving path and the advertisement list to the connection module 202 of the client 20 (Step 111).

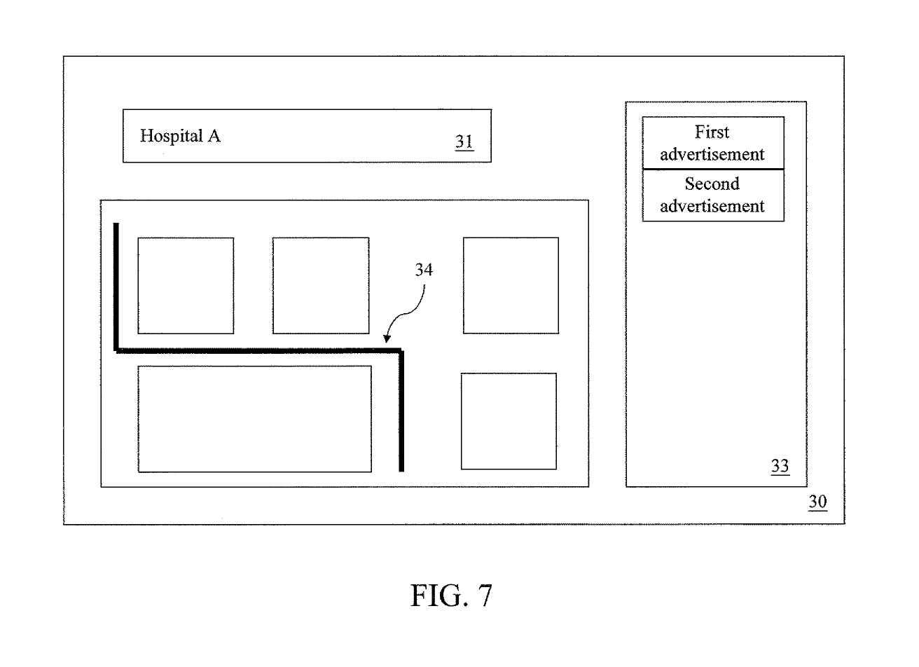

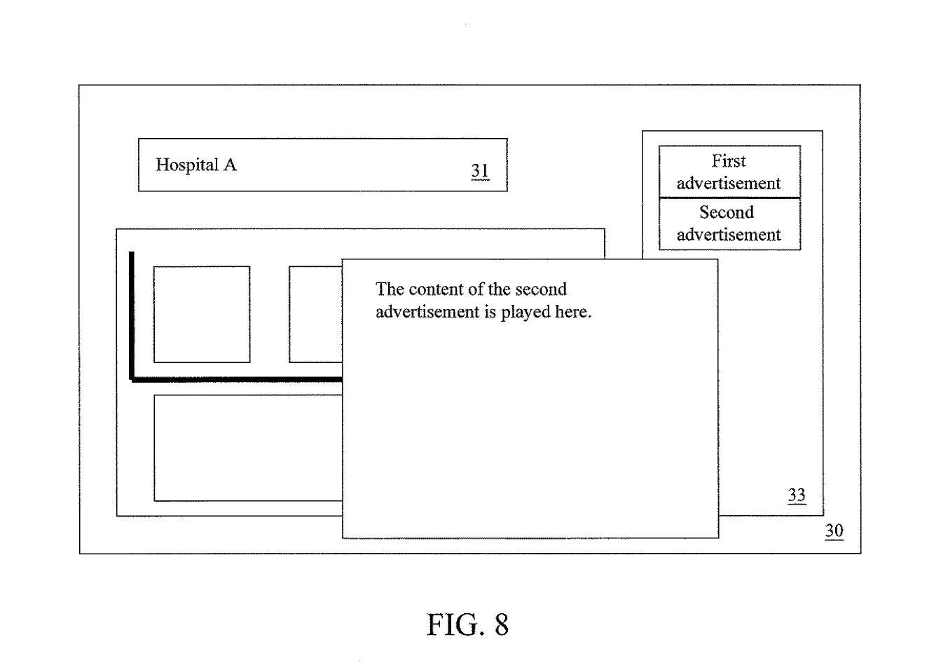

Referring to FIG. 7 and FIG. 8, FIG. 7 is a schematic view of a display result for implementing advertisement push and marketing according to the present invention, and FIG. 8 is a schematic view of advertisement playing for implementing advertisement push and marketing according to the present invention.

After the connection module 202 of the client 20 acquires the driving path 34 and the advertisement list 33, the display module 204 of the client 20 displays the driving path 34 on an electronic map 35, and also displays the advertisement list 33 (Step 112). The passenger clicks the advisement in the advertisement list 33, and when the second advertisement in the advertisement list 33 is clicked, the play module 203 of the client 20 plays the clicked second advertisement (Step 113). The playing result of the second advertisement is shown in FIG. 8.

The server 10 further includes the counting module 109 used for counting the clicked times of the advertisements in the advertisement list 33 (Step 114), and after the counting module 109 of the server 10 counts the clicked times of the advertisements in the advertisement list 33, subsequent operations such as data analysis and charging management can be conducted.

Referring to FIG. 4 again, each kind of data in the advertisement database 101 further includes preferential information, and the comparison module 103 of the server 10 further determines by comparison that the target location information 31 being “120°50′40″ E, 24°29′40″ N” falls in the location range being “120°50′35″ E, 24°29′45″ N”, “120°50′45″ E, 24°29′45″ N”, “120°50′35″ E, 24°29′35″ N”, and “120°50′45″ E, 24°29′35″ N” of the third kind of data (Step 115).

The query module 104 of the server 10 queries the preferential information being “the third preferential information” corresponding to the location range from the advertisement database 101 (Step 116), and the server transfer module 105 of the server 10 provides the preferential information being “the third preferential information” to the connection module 202 of the client 20 (Step 117).

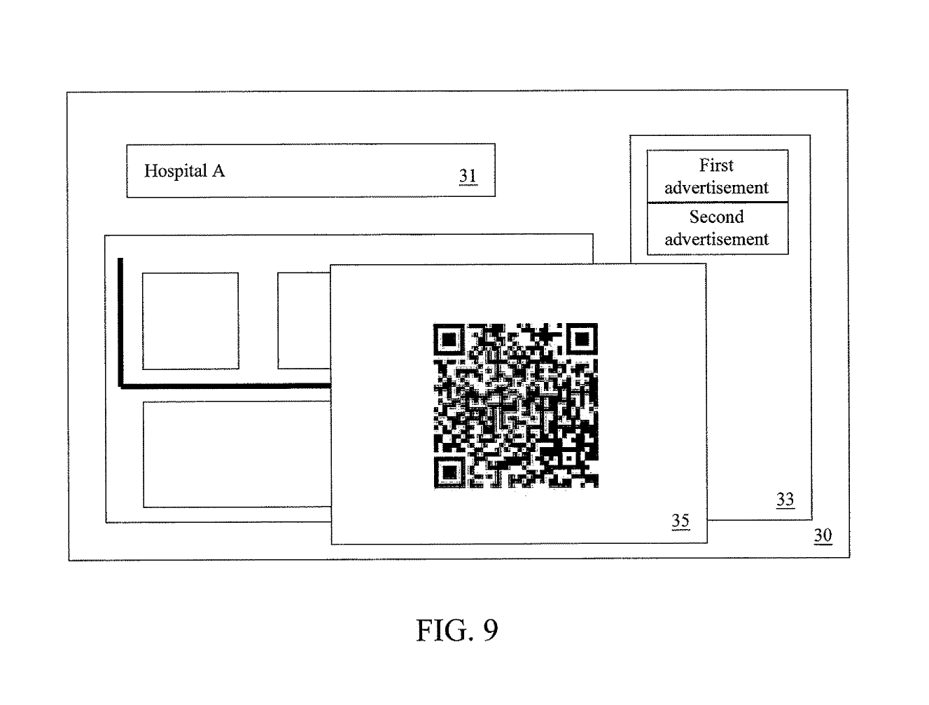

Referring to FIG. 9, FIG. 9 is a schematic view of a display result of the preferential information for implementing advertisement push and marketing according to the present invention.

The display module 204 of the client 20 displays the preferential information 35 being “the third preferential information” (Step 117). The promotional information 35 is illustrated as a two-dimensional barcode in the embodiment, which is not used to limit the present invention. The preferential information includes a combination of characters, images, and barcodes. The passenger may capture images of the preferential information by means of a handheld device, or acquire the preferential information from the client 20 in wireless (for example, WIFI, Bluetooth, and so on), so that the passenger may use the preferential information in a store at a destination after arriving at the destination.

Based on the above, it can be known that the difference between the present invention and the prior art lies in that in the present invention, the client provides the target location information and the location information, so that the server queries the advertisement corresponding to the location information according to the target location information and the location information, and feeds back the queried advertisement to be played for the user, thereby avoiding causing the boredom of the user when repeatedly watching a fixed advertisement.

By means of the technical means, the problem in the prior art that the existing vehicle-mounted device repeatedly plays a fixed advertisement and fails to play advertisements properly according to the vehicle location can be solved, thereby achieving the technical efficacy of implementing advertisement push and marketing.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A system for implementing advertisement push and marketing, comprising:
a server, further comprising:
an advertisement database, storing multiple data, each data comprising a location range and an advertisement which is corresponding to the location range;
a server receiving module, for receiving target location information and location information, and receiving the location information again at each a predetermined interval;
a comparison module, for comparing whether the location information falls in the location range of any data;
a query module, for querying the advertisement corresponding to the location range from the advertisement database, when the comparison module determines the location range which the location information falls in; and
a server transfer module, for transferring all the queried advertisements; and
a client, installed in a vehicle, and further comprising:
a client receiving module, for receiving the target location information and the location information;
a connection module, for establishing a connection with the server, providing the target location information and the location information which are from the client receiving module to the server receiving module, and acquiring the advertisement from the server transfer module; and
a play module, for cyclically playing all the received advertisements.

2. The system for implementing advertisement push and marketing according to claim 1, wherein the server further comprises a path planning module, for planning a driving path from the location information to the target location information, the server transfer module transfers the driving path to the connection module, and the client further comprises a display module for displaying the driving path.

3. The system for implementing advertisement push and marketing according to claim 1, wherein the server further comprises a generation module and a counting module, the generation module is used for generating an advertisement list from all the queried advertisements, the server transfer module transfers the advertisement list to the connection module, the client further comprises a display module for displaying the advertisement list, the play module is used for playing a clicked advertisement in the advertisement list, and the counting module counts clicked times of the advertisements in the advertisement list.

4. The system for implementing advertisement push and marketing according to claim 1, wherein the comparison module further comprises comparing whether the target location information falls in the location range, the advertisement database further comprises preferential information which is corresponding to the location range, the query module further comprises querying preferential information when the comparison module determines the location range that the target location information falls in, the server transfer module provides the preferential information to the connection module, and a display module displays the preferential information.

5. The system for implementing advertisement push and marketing according to claim 4, wherein the preferential information comprises a combination of characters, images, and barcodes.

6. A method for implementing advertisement push and marketing, comprising:
receiving target location information and location information by a client which is installed in a vehicle;
establishing a connection with a server by the client, and providing the target location information and the location information to the server;
pre-establishing an advertisement database which stores multiple data by the server, each data comprising a location range and an advertisement which is corresponding to the location range;
acquiring the location information again from the client at each a predetermined interval by the server;
comparing whether the location information falls in the location range of any data by the server;
when the server determines the location range which the location information falls in querying the advertisement corresponding to the location range from the advertisement database;
providing all the queried advertisements to the client by the server; and
cyclically playing all the received advertisements by the client.

7. The method for implementing advertisement push and marketing according to claim 6, further comprising:
planning a driving path from the location information to the target location information by the server;
providing the driving path to the client by the server; and
displaying the driving path by the client.

8. The method for implementing advertisement push and marketing according to claim 6, further comprising:
generating an advertisement list from all the queried advertisements by the server;
providing the advertisement list to the client by the server;
playing a clicked advertisement in the advertisement list by the client; and
counting clicked times of the advertisements in the advertisement list by the server.

9. The method for implementing advertisement push and marketing according to claim 6, further comprising:
comparing whether the target location information falls in the location range by the server;
querying preferential information corresponding to the location range from the advertisement database when the server determines the location range which the target location information falls in; and
providing the preferential information to the client by the server, and displaying the preferential information by the client.

10. The method for implementing advertisement push and marketing according to claim 9, wherein in the step of querying the preferential information corresponding to the location range from the advertisement database when the server determines the location range which the target location information falls in, the preferential information comprises a combination of characters, images, and barcodes.
